(19) United States
(12) Patent Application Publication
(10) Pub. No.: US 2021/0147212 A1
(43) Pub. Date: May 20, 2021

(54) SUSTAINABLE METHODS AND DEVICES FOR AUTOMATED DOSING OF A LAUNDRY PRODUCT

(71) Applicant: Conopco, Inc., d/b/a UNILEVER, Englewood Cliffs, NJ (US)

(72) Inventors: Deborah Jane COOKE, Chester (GB); Brian Patrick NEWBY, Bebington, Wirral (GB); Ellen Suzanne PIERCY, Northwich (GB); Katharine Jane SHAW, Bebington, Wirral (GB); Robert Lindsay TRELOAR, Hoole (GB)

(73) Assignee: Conopco, Inc., d/b/a UNILEVER, Englewood Cliffs, NJ (US)

(21) Appl. No.: 16/965,373

(22) PCT Filed: Jan. 29, 2019
(86) PCT No.: PCT/EP2019/052151

§ 371 Date: Jul. 28, 2020

(30) Foreign Application Priority Data
Feb. 2, 2018 (EP) 18155012.0

(51) Int. Cl. B67D 3/00; D06F 21/02; D06F 33/37; D06F 33/43; D06F 34/18; D06F 39/02

(52) U.S. Cl. CPC B67D 3/0041; B67D 3/0003; D06F 21/02; D06F 33/37; D06F 2103/04; D06F 34/18; D06F 39/022; D06F 39/024; D06F 33/43

(57) ABSTRACT

A laundry system for dispensing one or more ingredient compositions from ingredient reservoirs for supplying to a washing machine drum, the laundry system comprising: (i) an apparatus which comprises a dispensing device and multiple ingredient reservoirs; (ii) said multiple ingredient reservoirs comprising a recycled material and containing the various ingredient compositions in controllable fluid communication with the dispensing device and each ingredient reservoir comprising at least one ingredient reservoir identifier; (iii) said dispensing device being operable to selectively dispense portions of the ingredient compositions from respective ingredient reservoirs as a result of commands by the user to provide a dose of laundry product, and further comprising (iv) an ingredient reservoir control system for controlling said selective dispensing of respective ingredient compositions from specific ingredient reservoirs identified by respective ingredient reservoir identifiers such that the device can selectively dispense ingredient compositions from one or more identified ingredient reservoirs wherein the or each ingredient reservoir identifier comprises a data carrier for storing data regarding the condition of the ingredient reservoir and the ingredient reservoir control system is operative to modify the data stored on the data carrier.

The present invention relates to sustainable methods and devices for automated dosing of a laundry product.

Automated dosing offers advantages the laundering process much less labour intensive. Automated dosing may involve prefilled or refillable reservoirs or cartridges of laundry product which can be installed in a washing machine. The machine then doses from the cartridge according to a washing programme selected by the user.

W02009095003 discloses a device for cleaning articles. The device has individually dosable substances accommodated separately in containers. An element comprising indirect or direct data regarding the substance contained in the container. A unit is arranged on the device which allows acquisition of the data.

EP2913431 discloses a device/system for detecting the consumption of a medium in a washing or cleaning system. The medium is contained in a container and the container comprises a data carrier, for example an RFID tag. By means of the writing device, in particular the current filling level (of the medium) in the container can be inscribed as information on the data carrier.

The problem with many such devices is that there are recycling issues with RFID and other e-tags reducing the sustainability of such systems.

The present invention seeks to provides improved systems, methods and devices for sustainable automated dosing of a laundry product.

In a first aspect the invention provides a laundry system for dispensing one or more ingredient compositions from ingredient reservoirs for supplying to a washing machine drum, the laundry system comprising:

(i) an apparatus which comprises a dispensing device and multiple ingredient reservoirs;

(ii) said multiple ingredient reservoirs comprising a recycled material containing the various ingredient compositions in controllable fluid communication with the dispensing device and each ingredient reservoir comprising a recycled material and a at least one ingredient reservoir identifier;

(iii) said dispensing device being operable to selectively dispense portions of the ingredient compositions from respective ingredient reservoirs as a result of commands by the user to provide a dose of laundry product, and further comprising

(iv) an ingredient reservoir control system for controlling said selective dispensing of respective ingredient compositions from specific ingredient reservoirs identified by respective ingredient reservoir identifiers such that the device can selectively dispense ingredient compositions from one or more identified ingredient reservoirs wherein the or each ingredient reservoir identifier comprises a data carrier for storing data regarding the condition of the ingredient reservoir

In a further aspect the invention provides an apparatus for dispensing one or more ingredient compositions from ingredient reservoirs for supplying to a washing machine drum, the apparatus comprising:

(i) multiple ingredient reservoirs containing various ingredient compositions and comprising at least one ingredient reservoir identifier,

(ii) a dispensing device operable to selectively dispense portions of ingredient compositions from respective ingredient reservoirs so as to provide a dose of laundry product as a result of input by a user, and

(ii) an ingredient reservoir control system for controlling said selective dispensing of respective ingredient compositions from specific ingredient reservoirs identified by respective ingredient reservoir identifiers such that the device can selectively dispense ingredient compositions from one or more identified ingredient reservoirs wherein the or each ingredient reservoir identifier comprises a data carrier for storing data regarding the condition of the ingredient reservoir and the ingredient reservoir control system is operative to modify the data stored on the data carrier.

In a further aspect the invention provides a method for dispensing one or more ingredient compositions from ingredient reservoirs comprising a recycled material and containing various ingredient compositions for supplying to a washing machine drum comprising the step of controlled selective dispensing from specifically identified ingredient reservoirs, the or each ingredient reservoir comprising an ingredient reservoir identifier by which it is identified to an ingredient reservoir control system which controls said selective dispensing wherein the or each ingredient reservoir identifier comprises a data carrier for storing data regarding the condition of the ingredient reservoir and the method further includes the step of modification of the data stored on the data carrier by ingredient reservoir control system.

The method of dispensing preferably utilizes apparatus comprising
a. a computer module which is configured to receive input concerning a laundry load based on one or more of the following criteria:
   (i) stain identity;
   (ii) fabric identity;
   (iii) user requirements; and
   (iv) user preferences,

and preferably the method comprises the steps of:
a. providing input based on at least one of said criteria to the computer module and then
b. causing the device to determine, based on said information, a recipe for a laundry product which is optimised with respect to said input and composed of one or more ingredient compositions from respective ingredient reservoirs, and then
c. cause the device to effect controlled selective dispensing from specific ingredient reservoirs identified by an ingredient reservoir control system for controlling said selective dispensing of respective ingredient compositions from specific ingredient reservoirs identified by respective ingredient reservoir identifiers such that the device selectively dispenses ingredient compositions from one or more identified ingredient reservoirs; and

wherein the or each ingredient reservoir identifier comprises a data carrier for storing data regarding the condition of the ingredient reservoir and the ingredient reservoir control system modifies the data stored on the data carrier.

In a further aspect the invention provides a method for dispensing one or more ingredient compositions from ingredient reservoirs comprising a recycled material and comprising respective ingredient reservoir identifiers, the or each ingredient reservoir identifier comprising a data carrier for storing data regarding the condition of the ingredient reservoir the method comprising the steps of:

a. receiving user input regarding laundering of fabrics

b. in response to said user input, generating a signal and/or data for activation of an ingredient reservoir control system thereby effecting controlled selective dispensing of respective ingredient compositions from specific ingredient reservoirs identified by respective ingredient reservoir identifiers and

d. modification by the ingredient reservoir control system of the data stored on the data carrier.

The method preferably incorporates the steps:
a. displaying fabric data based on one or more of the following criteria
(I) stain identity;
(ii) fabric identity;
(iii) user requirements; and
(iv) user preferences;

b. receiving data input by a user, said input data comprising selected fabric data from step 1;

c. displaying said input data;

d. comparing said input data with ingredient composition data, which may be stored on computer readable storage medium, and thereby formulating one or more laundry treatment recipes, said recipes being bespoke to the user input data;

wherein said ingredient combination data comprises:
i. multiple ingredient composition data;
ii. multiple combinations of said ingredient compositions; and
iii. multiple treatment (e.g. stain) categories related to said ingredient composition combinations.

e. generating a signal and/or data for activation of an ingredient reservoir control system for controlling selective dispensing of respective ingredient compositions from specific ingredient reservoirs identified by respective ingredient reservoir identifiers.

In a further aspect the invention provides a computer-implemented method for dispensing one or more ingredient compositions from ingredient reservoirs comprising a recycled material and comprising respective ingredient reservoir identifiers, wherein the or each ingredient reservoir identifier comprises a data carrier for storing data regarding the condition of the ingredient reservoir, the method comprising the steps of:

a. receiving user input regarding laundering of fabrics

b. in response to said user input, generating a signal and/or data for activation of an ingredient reservoir control system to implement controlled selective dispensing of respective ingredient compositions from specific ingredient reservoirs identified by respective ingredient reservoir identifiers.

c. modification by the controller, of the data stored on the data carrier.

In a further aspect the invention provides a combination of ingredient reservoirs for supplying one or more ingredient compositions to a washing machine drum, wherein each ingredient reservoir comprising a recycled material and comprises a respective ingredient reservoir identifier for storing data regarding the condition of the reservoir.

In a further aspect the invention provides an ingredient reservoir containing an ingredient composition for supplying to a washing machine drum, wherein the ingredient reservoir comprising a recycled material and comprises an ingredient reservoir identifier.

With the arrangement of the invention, reservoirs can specifically identified to the dispensing device so that multiple reservoirs can be used and the usage tracked by modification of data on each reservoir. This feature means that the usage history of the reservoir can be updated as the reservoir is used.

As used herein, the term “condition of the ingredient reservoir” means primarily the condition of the reservoir itself (the component containing the product). More preferably the term includes data regarding the recycled material or its/the reservoir's recyclability. Each reservoir may have a unique identifier name or code so it is distinguishable from any other reservoir. Each reservoir may carry data tracking the various stages of its entire life so not only when it contains laundry product and is in use in e.g. a consumer home but also when it is empty and the reservoir is disposed of.

Preferably the ingredient reservoir comprises a recyclable material.

Thus a re-usable recycled and recyclable reservoir is provided. A reservoir can be made from recycled materials, used and re-used. The usage is tracked by the reservoir and the number of times/types of usage can be recorded. The usage can be limited to the expected lifespan of a recycled material.

Thus, with recycled materials which have limited lifespans due to degrading over time or under certain condition, these can still be used and re-used for that period. After each use, the reservoir can be rejuvenated as will be described below. Once the lifespan of a material is exceeded (or just before) the reservoir data may reflect this and alert the controller so the reservoir can be removed and, because a recyclable material has been used, it can be recycled (ground, melted etc). The reservoir may carry data regarding expected lifespan or usage times, cycles and/or controllers may carry such data. The reservoir may simply carry usage and the controllers use this data (comparing against expected lifespan data) to issue notifications regarding the need to prevent further usage of such reservoirs.

As will be seen, the invention facilitates re-use of recycled reservoirs by ensuring monitoring of the reservoir's passage through reservoir ‘rejuvenation’ operations.

The data may include storage, transit, cleaning e.g. sanitizing data stored with respect to time. This can ensure reservoirs spend appropriate time periods at certain stations e.g. cleaning stations so that e.g. hygiene standards are met.

Recording and monitoring of the reservoir status enables the implementation of a monitored and optimized circular system for using re-usable auto-dosing reservoirs.

Thus in further aspects the invention provides a circular system as described below.

The term “circular system” as used herein means a system of reservoirs of the invention, use stations and recycling or ‘rejuvenation’ stations. The reservoirs move from station to station in a closed loop, being used and re-used without destructive/chemical recycling or being thrown away unless e.g. faulty or broken. The advantage of such a system of usage is that it supports a circular economy. In traditional linear system goods exit and are disposed of as refuse. In a circular system, the article stays in use and is recovered and regenerated instead of being disposed of. With the invention, reservoirs can be re-used without chemical recycling unless e.g. faulty or broken. Thus reservoirs may be purchased by consumers, installed and used in e.g. washing machine and then when empty, returned to a rejuvenation facility cleaning and refilling. Re-filled reservoirs are then transported back out to retail stores or direct to consumers for re-sale and thus continue through this cycle. The reservoirs may continue looping the again and again until withdrawn. New reservoirs can enter the system e.g. to replace broken, faulty reservoirs and begin looping the cycle of use and re-use, but the volumes needed to be manufactured can be lower. Throughout the system, reservoirs are monitored at various different stations.

With a circular system, less plastic can be used due to re-use of existing reservoirs, and because data is recorded regarding the rejuvenation (cleaning and refilling) of reservoirs, consumers can have greater faith in the re-used reservoir being sufficiently clean before refilling and re-sale. Aged reservoirs may be removed and recycled.

Thus accordingly, in a yet further aspect the invention provides a circular system for using re-usable auto-dosing reservoirs, the system comprising:

a. at least one ingredient reservoir comprising a recycled material and containing an ingredient composition for supplying to a washing machine drum, wherein the ingredient reservoir comprises an ingredient reservoir identifier, said reservoir identifier comprising a data carrier operable to carry data relating to usage and/or treatment of the reservoir at one more stations; and

b. reservoir controller comprising at least one reader able to read said data relating to usage and/or treatment of the reservoir at one or more stations wherein said stations of the circular system comprise:

a. a use station and

b. a reservoir cleaning station where the reservoir is cleaned;

and preferably

c. a reservoir filling and/or re-filling station where the reservoir is filled or re-filled with an ingredient composition. The reservoir controller of the or each station is also able to modify the data stored on the reservoir identifier.

In a yet further aspect the invention provides an ingredient reservoir comprising a recycled material and comprising a ingredient reservoir identifier, said reservoir identifier comprises a data carrier storing data relating to said treatment of the reservoir at any one or more of the stations:

a. a use station and

b. a reservoir cleaning station where the reservoir is cleaned;

and preferably

c. a reservoir filling and/or re-filling station where the reservoir is filled or re-filled with an ingredient composition supplying to a washing machine drum. The reservoir controller of the or each station is also able to modify the data stored on the reservoir identifier.

The refilled reservoir may then be transported to a distributor, store for sale to consumers or transported direct to consumers.

Preferably the reservoir controller incorporates a data writer for writing data regarding the status (condition) of the reservoir to a data carrier of the or each reservoir identifier.

Preferably the controller comprises a reader/writer function at each station. Thus each station can write to the data carrier regarding the status (condition) of the reservoir. For instance each station may input data to indicate that the reservoir passed through that station successfully.

Preferably the reservoir controller controls the passage of the or each reservoir individually, to and from each station in response to data carried on the data carrier. In this way the ‘life’ of the reservoir can be tracked for all key events of usage and treatment.

Preferably, each station comprises a reader operable to read data regarding previous stations visited. If the station recorded as the previously visited station is not the correct station according to the proper cycle then this may trigger a notification or alarm etc. In this way if a station is accidentally skipped, it can be noticed quickly.

The or each reservoir preferably remains in the system for at least one entire cycle. One cycle for an individual reservoir comprises use as in (a) and then treatment as in (b) and/or (c), preferably (b) and (c). Preferably the or each reservoir remains in the system for at least two cycles and more preferably at least three cycles and most preferably at least ten cycles.

The reservoir cleaning station may effect sanitization of the reservoir by e.g. anti-bacterial, hygiene treatments such as bleaching.

Preferably data is written to the data carrier of any reservoir along with corresponding time and date. So, the time spent at any station is recorded.

Preferably the data carrier carries data relating to the reservoir's usage in or transit through one or more of the stations. Preferably data is written to the data carrier of any reservoir along with corresponding time and date. So, the time spent by the reservation at any station is recorded. Time spent undergoing individual processes may be recorded to the reservoir's tag e.g. time spent undergoing detersive cleaning or rinsing.

The reservoir control system preferably comprises a reader or sensor which senses the presence of a reservoir identifier and informs the system of the presence of a reservoir. Ensuring the correct reservoir was in place may be achieved by mechanical and/or visual lock and key arrangements of reservoir and dispensing device. So the reservoirs with different ingredient compositions may be shaped differently and fit into corresponding shaped receiving portions of the dispensing device. The shape difference may be in the profile of the whole reservoir or simply in the fluid connection parts. Colour coding of reservoirs and receiving portions may be used to aid the consumer to insert the correct reservoir.

Preferably the reservoir control system is connected (either directly or via a computer module which forms part of a washing/dispensing machine) to a remote retail system to enable automated replenishment, replacement, or upgrade of reservoirs and further preferably automatic delivery to the consumer, or where new or additional consumer goods may be recommended.

The reservoir control system may comprise one or more computing modules. Throughout the present specification, the expression ‘module’ is intended to encompass a functional system which may comprise computer code being executed on a generic or a custom processor, or a hardware machine implementation of the function, e.g. on an application-specific integrated circuit.

Preferably the reservoir identifier comprises at least one data carrier. Preferably the reservoir control system comprises at least one reservoir reader operable to read data from said data carrier. This allows an intelligent system where data carried and communicated is specific to the reservoir and/or the reservoir contents (the ingredient composition).

There may be multiple reservoir identifiers, e.g. one or more devices per ingredient reservoir in combination with a single reader. Alternatively or additionally there may be multiple readers, e.g. one or more readers for each reservoir.

The reservoir identifier data carrier stores data regarding the condition of the reservoir. The reservoir control system is operative to modify this data as stored on the data carrier.

The terms “modify” and “modification” include deletion, amendment, replacement, transfer, copying of data; supplementing/adding to data, updating data, including adding a data to an empty data carrier for the first time or after data has been deleted.

Thus the reservoir control system (including reservoir reader) has write functionality to modify the identifier data as defined above on the reservoir identifier. In this way data stored locally on each reservoir regarding its condition e.g. fill-level or amount of ingredients contained can be updated. So for example, a reservoir control system may calculate fill levels according to a given initial fill volume/mass data (which may be calculated or provided e.g. written to the data carrier during manufacturing) and subsequent dosage data. The control system may then update the condition data stored by the reservoir identifier's data carrier with the current fill levels.

Preferably the data is in digital form.

Preferably the data carrier comprises an electronic and/or electro-magnetic and/or magnetic data carrier. The reservoir identifier is preferably at least in part electronic and/or electromagnetic.

The reservoir identifier may comprise computer readable medium and may even carry computer executable instructions on the medium. The reservoir identifier may comprise a programmable microprocessor, small chip, disk, or radio frequency ID (RFID) tag/reader, bar codes, optical character recognition (OCR), smart cards, biometrics (e.g. bio-recognition such as fingerprint, voice, iris, facial recognition system, proximity (prox) card, smart card, contactless smartcard, near field communication (NFC) devices, printed electronic id devices, or any combination of the above.

The reservoir identifier and reservoir control system may be part of laundry automatic identification & data capture (AIDC) system comprising identified reservoirs and a recipe design system/apparatus with associated reservoir identifier reader. AIDC may further include biometrics (e.g. bio-recognition such as fingerprint, voice, iris, facial recognition system or any of the) for personalisation. The laundry AIDC may link to internet and for example prompt the user to buy more reservoirs etc.

Preferably the reservoir identification device is comprised within the reservoir, e.g. it may be contained within a reservoir wall or base or other part. In this way, it can be protected from damage as the reservoir is inserted into the dispensing unit. Accordingly, preferably the reader does not require line of sight of the identifier. Suitably, a the reservoir identification device comprises an electromagnetic tag/reader which communicate using electromagnetic fields/waves which are non-visible and so do not require line of sight.

Preferably the reservoir identifier comprises an RFID (e.g. RFID tag or label) and the reader is an RFID reader.

Alternatively or additionally the reservoir identifier and/or reader comprise near field communication (NFC).

The system may also include an NFC-enabled smartphones or smart device or similar incorporating NFC read functionality. The allows the user to interrogate the reservoir as to its identity using e.g. a smartphone or smart device.

Preferably the RFID reader comprises an anisotropic antenna, i.e. an antenna that radiates power differently and unequally in the elevation and azimuth fields.

More preferably the RFID reader comprises a directional antenna, whereby the antennas emit concentrated RF power toward a targeted area. The antennas may have an azimuth and elevation beam width of substantially the same degree in order to provide a more focused ‘beam’.

With readers that do not require line of sight, whilst they enable embedded ID devices protected from installation damage, the problem arises that reservoirs may be identified before installation. For example the user may power the machine (by activating a power ‘on’ button) whereby the RFID reader is operable to read a reservoir which is not yet installed but positioned, by chance, next to the device. In this instance the reader may signal to the dispenser that a reservoir is installed, when in fact it is not. Such a signal might induce a pump to draw fluid or other activity which would be undesirable and possibly damage the pump. Accordingly preferably the RFID reader comprises a low gain antenna, preferably with gain less than 9 dBi. The antenna is a proximity antenna. Preferably the range of the antenna is computed as the distance from the reader location and the tag when the reservoir is in place. Suitable read range is 2-10 cm preferably 2-8 cm. With this feature, the antenna can be powered to read only devices with are installed inside the dispensing device.

Beam width as used herein means the angle between two points on the same plane where the radiation falls to ‘half power’, or 3 dB below the point of maximum radiation. It can also be thought of as the peak effective radiated power of the main lobe. There are two beam widths—azimuth (horizontal) and elevation (vertical). Preferably the reader antenna emits a beam having at least the azimuth or the elevation beam widths being less than 90 degrees. The beam should be narrow and acute. This ensures the antenna is focused on the RFID tag only and that it does not waste energy.

Preferably the identifier e.g. tag is integral to the reservoir, e.g. embedded, in-moulded etc. The tag may be part of an in-mould label (IML). The tagged label becomes an integral component of the plastic item. The tag may be embedded directly into the bottle during moulding e.g. blow moulding.

The identifier e.g. tag may be applied post-moulding of the reservoir e.g. welded e.g. ultrasonically weld to the reservoir.

The RFID unit may operate at low frequency (LF) 125-134 kHz, high frequency (HF) 13.56 MHz or ultra high frequency (UHF) 856 MHz to 960 MHz. Preferably RFID tags are such that they can also be read by NFC devices e.g. HF (operating at the same frequency) and preferably compliant with ISO 15693.

The identifier e.g. tag may be part of an In-Mould Label (IML) and many comprise a passive low frequency (LF), high frequency (HF) or ultra high frequency (UHF) inlay, covered by unique, protective durable materials and adhesives that shield the inlay during the injection or blow-mould process. This label is specially designed to withstand high temperature and pressure during the moulding process and has the option of including printed logo and barcode on top layer.

UHF RFID tags are strongly affected by objects containing metal (reflection of RF energy) or water (absorption of RF energy). Therefore preferably the reservoir comprises a plastic. Preferably the dispenser comprises plastic around the part where RFID reader sits. Plastic also affords protection of metal parts against certain chemicals which may be in the laundry product, or used during cleaning of the reservoir or may be present on kitchen surfaces (strong bleach for example).

Reservoirs may be arranged around a single reader to allow short range antenna. For example reservoirs may be in a radial configuration.

Preferably the identifier e.g. tag is passive such that is collects energy from an associated reader, e.g. a passive RFID will collect energy from a nearby RFID reader's interrogating radio waves. This is preferable to active identifier e.g. tags which require a local power source (such as a battery) and may operate hundreds of meters from the RFID reader. This could mean that false readings were obtained.

Preferably the reservoir identification device comprises a data carrier. Data may be stored on the data carrier using digital encryption, such as digital keys (commonly known as signatures) readable by the reader. The reader (which may be in conjunction with a computing device of the system of the invention) can the check whether or not the docked reservoir is acceptable (i.e. authenticates the reservoir) and can decide what to do next based on its internal algorithms. The digital signature can have varying levels of security logic and cryptographic algorithms built in such that it is secure and difficult to copy.

Preferably the tag comprises an anti-cloning function, e.g. RFID comprising Physical Unclonable Function (PUF) or integrated physical unclonable function (IPUF). Preferably the tag has security protocols for the detection of the authenticity of a product when it is equipped with such a system.

The data carrier may contain information which is encoded so that, for example, the name of the ingredients is stored as a value which is then identified (read) by the reader or controller. After comparison with a look-up table of ingredient numbers and names the controller identifies the ingredients which may then be e.g. used in recipe calculation displayed to a user. This can reduce the amount of data stored on the data carrier of each reservoir identifier.

The identifier e.g. tags may comprise read-only data e,g. manufacturing data or a factory-assigned serial number that is used as a key into a database; and also data which can be modified (read/write), where object-specific data can be written into the tag by the system user. Field programmable tags may be write-once, read-multiple; “blank” tags may be written with an electronic product code by the user.

In the case of reservoir identifiers/readers requiring line-of-sight, such as barcodes, or QR codes, preferably the mutual shape of reservoir and dispensing device provides that the reader has line of sight of the reservoir identifier. For example, the reservoir, when installed in a dispensing device, may comprise surfaces which are adjacent surfaces of the dispensing device such that identifiers and readers located on respective surfaces of the reservoir and dispenser have line of sight.

The or each ingredient reservoir may contain a single ingredient or multiple ingredients. They may contain a single active ingredient which is e.g. stabilized, solubilized in other carrier ingredients. Preferably the data also relates to the condition of the contents contained in the reservoir e.g. the laundry product and further preferably both of these. This further improves monitoring as the data can record any contents, e.g. laundry product or rejuvenation cleaners. Thus the data may modified regarding ingredients which have been dispensed.

The data carrier preferably carries information specific to the contents of the reservoir (i.e. the reservoir in/on/to which the reservoir identifier is attached/embedded etc).

Preferably the data carrier carries information regarding the ingredient composition contained in the reservoir so that ingredient compositions are identified specifically to the dispenser e.g. fill-level or amount of ingredients contained can be updated. So for example, a reservoir control system may calculate fill levels according to a given initial fill volume/mass data (which may be calculated or provided e.g. written to the data carrier during manufacturing) and subsequent dosage data. The control system may then update the condition data stored by the reservoir identifier's data carrier with the current fill levels. The data may also comprise manufacturing details e.g. location, date, recommended dosing data e.g. volume, mass, that may be useful for the washing/dispensing machine. This data may then be displayed by the a user interface. The data may be accessed by the machine to determine a suitable washing program.

The data may relate to reservoir composition: as in quantity of ingredient composition contained/remaining in the reservoir. This data may be read by the identifier from the reservoir control system/computer module of a washing/dispensing machine and stored on the identifier. The quantity of ingredient composition may comprise a liquid level indicator which utilizes an light source e.g. LED and with the light source opto-electronically cooperating light receiving elements.

The data preferably comprises data relating to reservoir. Advantageously the data relates to the number of times the reservoir has been used i.e. any one or more of: having been filled with ingredient composition, used in a machine to dispense ingredient composition, cleaned; refilled, transported, stored etc.

Preferably, some or all data is stored with associated time data.

Preferably the data is stored additively, so e.g. current fill level data may be stored in addition to historical fill level data.

If data is stored both additively and with associated time data (e.g. time stamp) patterns of changing values may be stored e.g. changing fill levels may be stored with respect to time and from this, patterns of usage can be stored on the container and accessed by the manufacturer.

The use station may comprise a washing machine in which the reservoir is installed, or in any way controllably, fluidly connected for dispensing of the ingredient composition from the reservoir or a standalone dispensing station separate from a washing machine, in which the reservoir is installed, or in any way controllably, fluidly connected for dispensing of the ingredient composition from the reservoir.

In the case of the reservoir control system being connected (either directly or via a computer module which forms part of a washing/dispensing machine) to a remote retail system to enable automated replenishment, replacement, or upgrade of reservoirs and further preferably automatic delivery to the consumer, this may be in response to data carried on the data carrier. For instance if the data indicates that the reservoir has been through a specified number of cycles of the above circular system may trigger automated replenishment or replacement with a new reservoir which has not yet entered the circular system together with instructions to the consumer to recycle or return the reservoir to the manufacturer.

Preferably when a reservoir identifier is not present, or in the context of a reservoir identifier having an incorrect or deficient data, no dispensing occurs and instead the user is informed that a fault exists.

A reservoir identifier may be in/on each of said multiple reservoirs. The reservoir identifier may be provided on e.g. attached to a surface of a bottle or bottle label or at least partly contained in the reservoir, e.g. at least but preferably wholly embedded/implanted in the container material implanted. Attachment or embedding may be during moulding of the container or during subsequent processes, e.g. labelling of the reservoir. An advantage of this is that the reservoir may undergo cleaning and refilling without damage to the reservoir identifier so that the reservoir identifier survives cleaning, refilling but remains in/on the reservoir at all times during the reservoir's passage through a cycle, and also resists counterfeiting and so ensure authenticity and therefore safety especially in the case of concentrated ingredients such as enzymes, bleaches, surface treatment agents e.g. waterproofing additives.

In the case of reservoir identifiers which are at least partly contained in the reservoir material e.g. some embedded/implanted but which require line-of-sight with a reader for data communication therebetween, the reservoir may comprise at least one transparent portion locating said line-of-sight reservoir identifier, whereby transparency provides line-of-sight with the reader.

The reservoir identifier may be removable from a body portion of the reservoir—such as a removable lid or removable portion as follows

The reservoir may comprise a body portion which contains the ingredient composition and a removable portion (removable from the body portion) e.g. closure, lid and this removable portion may comprise the reservoir identifier. The removable portion may connect with the washing machine or dispensing device or rejuvenation station devices as described in more detail below. This affords the advantage that the remaining part of the reservoir can be made entirely out of recyclable material which can be easily recycled without contamination by metal parts of e.g. RFID chips etc. or by paper-containing labels etc. The portions may be attached, in use, by co-operating screw-threads, snap engagement, or other secure attachment. The attachment may be secure in that it requires power to detach or that detachment results in breakage (preventing further use). This would prevent consumers from detaching inadvertently but would allow detachment with industrial power equipment or destruction during recycling which is less likely to be a problem.

Preferably at least the body portion comprises a recycled material.

As used herein, the terms “recycled material” and “recyclable material” are intended to include plastic, paper, metal, glass.

Preferably the recycled material comprises a polymer selected from the group consisting of post-consumer recycled polyethylene (PCR-PE), post-industrial recycled polyethylene (PIR-PE), regrind polyethylene and a mixture thereof. Preferably the PE is high density (HDPE).

Alternatively, the recycled material comprises a polymer selected from the group consisting of post-consumer recycled polypropylene (PCR-PP), post-industrial recycled polypropylene (PIR-PP), and a mixture thereof;

Alternatively, the recycled material comprises a polymer selected from the group consisting of post-consumer recycled polyethylene terephthalate (PCR-PET), post-industrial recycled polyethylene terephthalate (PIR-PET), regrind polyethylene terephthalate, and a mixture thereof; or a polymer selected from the group consisting of a post-consumer recycled polyester of furan dicarboxylic acid, a post-industrial recycled polyester of furan dicarboxylic acid, a regrind polyester of furan dicarboxylic acid, and a mixture thereof; with the proviso that (i) and (ii) are either both PET or both a polyester of furan dicarboxylic acid.

The reservoir may comprise at least 10 wt. % of a polymer having a bio based content of at least 90%, based on the total weight of the reservoir. Preferably the bio based polymer corresponds to the recycled polymer, for example if the recycled polymer is PE, then likewise the polymer having bio-based content is also PE preferably HDPE. The bio-based content may be virgin or re-cycled.

The reservoir may be wholly or partly transparent. Preferably the transparent portion having a light transmittance of at least 50%

The transparent portion is preferably capable of parallel light transmittance.

“Parallel light transmittance” as used herein means transmitting light without appreciable light scattering. Preferably the degree of light scattering is less than 50%, 40%, 30%, 20%, 10%, 5%, 3%, 1%.

“Scattering” as used herein refers to both wide angle scattering and small angle scattering. Wide angle scattering causes what is referred to as haze or loss of contrast, whereas small/narrow scattering reduces the see-through quality or clarity. Hence it is preferable that haze is minimized and clarity maximized by minimal narrow and wide angle scattering.

The total light transmittance provides part of the measure of the reservoir's visual transparency. However, multiple parameters may be maintained, in addition in particular wide and narrow light scattering (reduction of haze and maximization of clarity).

“Light” means visible (to the human eye) light, which is generally in the range 330-700 nm.

“Total light transmittance” means the ratio of transmitted light to the incident light.

Preferably the reservoirs are, in use, housed in respective housings of the dispensing device. The housings may comprise an enclosure, recess, frame or any suitable structure.

Preferably, each reservoir and corresponding recess have corresponding shape and/or configuration such that the respective reservoir identifier of the reservoir and dispensing device are in communicable registration i.e. that data carried by the reservoir identifier can be read by the reader.

Preferably each reservoir is in controllable fluid communication with the dispensing device, such that flow is from specifically identified reservoirs by means of the or each reservoir identifier. Preferably the dispensing device comprises a nozzle which dispenses the product into e.g. the wash liquor or dosing unit as appropriate.

The respective ingredient compositions are separate and segregated from one another by separate, segregated reservoirs each with its own reservoir identifier.

The compositions from the various reservoirs may be dispensed directly into the wash liquor or dosing unit if provided (as it is not necessary that the various compositions are mixed before use)

Compositions may be dosed sequentially or concurrently.

The apparatus may comprise a pre-mixing chamber, and compositions may be dispensed via a pre-mixing chamber, which mixes two or more compositions prior to dispensing. Individual ingredient compositions may be dispensed into said chamber, where they may be mechanically mixed (by stirring or agitation, for example), or may naturally disperse and mix as each component is added.

The reservoirs may be integral to the housing of the device or, more preferably, they may be provided as pre-filled reservoirs or cartridges that cooperate with the housing of the device, such that the composition in the reservoir is in controllable fluid communication with the dispensing device. Preferably the dispensing device comprises a nozzle for dispensing the composition into e.g. dosing unit, wash liquor of a machine or a pre-mixing chamber as appropriate.

A reservoir cartridge may have stiff walls. In other words, the cartridge may retain its shape regardless of the amount of laundry product in the reservoir. A reservoir cartridge may have flexible walls. It will be appreciated that the cartridge may be configured to suit the overall design and shape of the device. Said reservoir cartridge may be, without limitation, a pouch or stiff plastic container.

Each reservoir cartridge may be fixable within the device such that the contents of the reservoir are sealable by a valve. Suitably, therefore, the cartridge comprises mating means configured to engage with complementary mating means on the device such that, when in place, the reservoir cartridge is held securely and laundry product within the reservoir cartridge is contained or released according to whether the valve of the device is in a closed or open state. In other words, the cartridge may comprise a connecting portion which mates with a complementary connection portion of the device.

Additionally or alternatively, the contents of the reservoir may be supplied by pressure and/or vacuum generated within the device. It will be appreciated that the device may have a pump to move the compositions from the reservoirs to the dosing nozzle, optionally via a pre-mixing chamber, to be dispensed.

Accordingly, each reservoir cartridge may be fixable to the device by mating means configured to engage with complementary mating means on the device such that, when in place, the reservoir cartridge is held securely and laundry product within the reservoir cartridge is contained or released according to whether the pump is on or off.

In a further aspect, the invention provides a reservoir cartridge comprising a composition as described here. The cartridge is fixable to the device such that the content of the cartridge is in controllable fluid communication with a device as described herein.

Embodiments of the invention may also provide a kit for a user to formulate bespoke doses of laundry product, wherein the kit includes a combination of reservoirs providing segregated stocks of laundry product components as described herein, optionally together with directions for combining selected portions of stock components in order to provide various alternative options for a dose of laundry product. A kit may optionally include a dosing unit for accommodating a dose of laundry product to be supplied to a washing machine, suitably by placing a dosing unit in a washing machine drum.

The apparatus may comprise a dosing unit.

The dosing unit may be a conventional dosing ball, or may have one or more features designed to complement or otherwise interact with the device. In some cases, the dosing unit seals the product within a chamber inside the unit, opening during the wash cycle to form a wash liquor.

The apparatus may be located externally of the washing machine and may be suitable for placing on a countertop or building into a kitchen unit. In other words, it may be self-contained. This is also referred to herein as standalone. may be adapted to be manually placed in the washing machine, especially in the washing machine drum. The dose of laundry product may also be supplied to the drum via a drawer

Alternatively the apparatus may be associated with the washing machine such that a dispensing device is located in a washing machine and is operable to dispense portions of components from reservoirs into a washing machine drum as a result of input by a user. Components may be dispensed directly into the water flow to form a wash liquor or into a chamber or pipe through which water subsequently flows.

The method may comprise providing input to the computer module; then dispensing laundry product into a dosing unit; then introducing said laundry product into a washing machine; then starting a washing machine program.

Where the device is integral to the washing machine, the method may comprise providing input to the computer module then starting a washing machine program.

The fabric substrate may be any suitable fabric for treatment e.g. garments, bedding, towels. Multiple fabric substrates under consideration for washing may be termed ‘wash load’.

Ingredient compositions are preferably in liquid form but alternatively or additionally they may comprise gel, powder, beads, tableted solids, capsules, gel-in-tab.

Various examples of the invention will now be described by example only, without limitation and with reference to the following diagrammatical drawings in which:

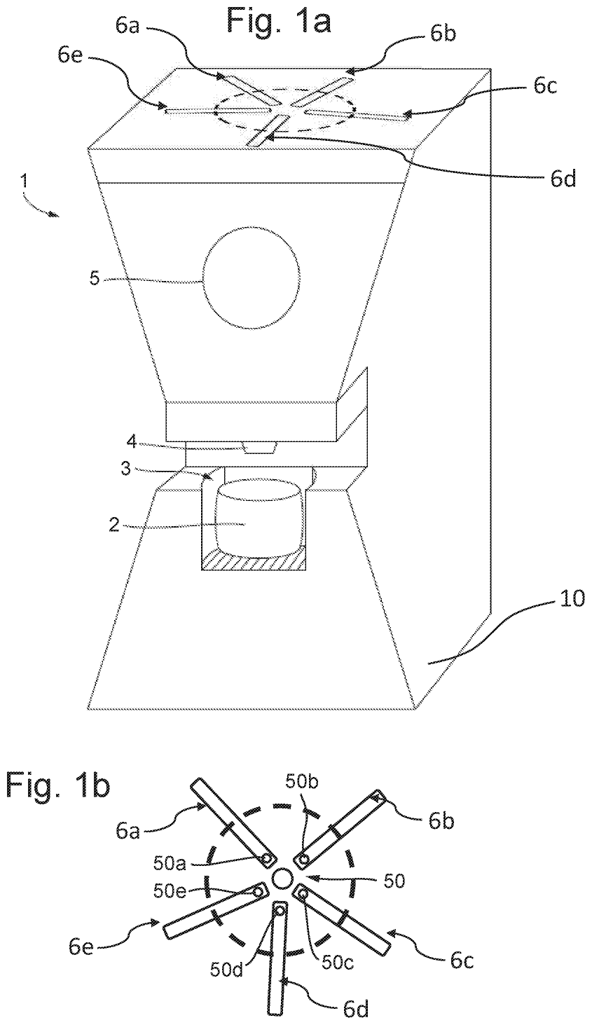

FIG. 1a shows a representative drawing of the apparatus of a standalone example of the invention

FIG. 1b shows an enlarged plan view of the apparatus of FIG. 1 with an arrangement of reservoir cartridges in the dispensing device

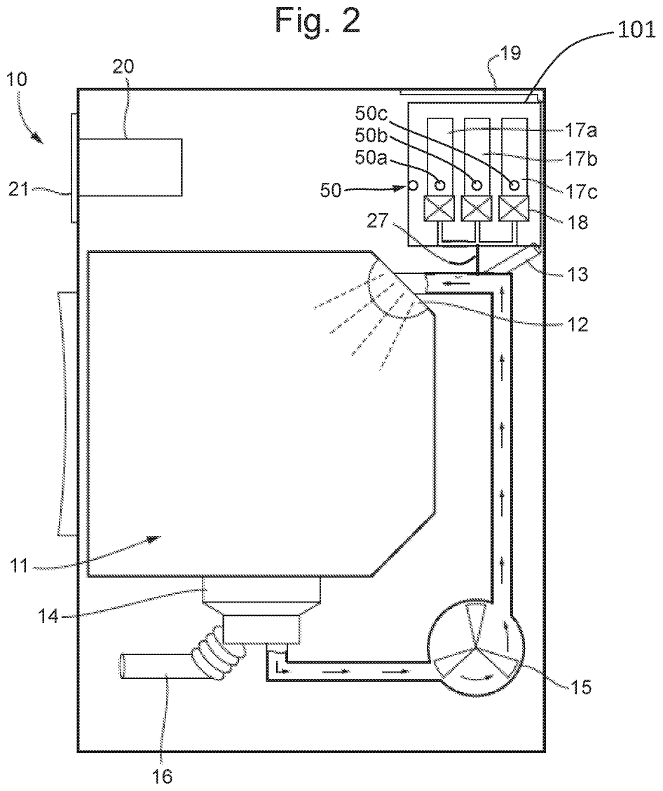

FIG. 2 shows a cross-section drawing of a device according to the present invention wherein the device is integral to a washing machine.

The apparatus as illustrated in FIGS. 1a and 1b has a dispensing device 1 and a dosing unit 2. In one embodiment the dispensing device flares out toward the top 11 and the base 10 The apparatus is a standalone device, designed to rest on its wider base 10 on a countertop or similar. For example, it may be placed on a countertop in a kitchen or utility room, or may be placed on top of a washing machine. It may also be built into a kitchen unit.

As illustrated, the dosing unit is a conventional dosing ball, which is typically made of plastics material. In use, the dosing unit is placed in a dispensing area 3 located underneath a nozzle 4. As illustrated, the dispensing area 3 is a recess provided in the device housing, and the dosing unit 2 is placed on a surface provided in the housing. However, it will be appreciated that the housing may be shaped in different ways such that, for example, the dosing unit is placed directly on the countertop (or other surface on which the device is placed) in use.

Laundry product ingredients are dispensed into the dosing unit 2 via the nozzle 4. As shown, only one nozzle 4 is used. However, it will be appreciated that more than one nozzle may be provided. For example, different reservoirs may be in fluid communication with different nozzles such that a first reservoir is in fluid communication with a first nozzle and a second reservoir is in fluid communication with a second nozzle.

The device has a control/information interface 5. As illustrated, the interface 5 is a touch screen provided in the housing that both displays information and allows selections and information to be inputted to a computer module (not shown).

However, in other embodiments the device may be provided with a panel having buttons, dials or similar for inputting information. In other embodiments, input may be conveyed via command or gesture. It will be appreciated that a display screen in the housing of the device is not essential. The device may be configured for use without a display screen, or an external display screen on for example a phone or tablet may be coupled to the device (for example, via Bluetooth or similar). The external user device may include a voice-activated device such as smart speaker Amazon Echo, Google Home, Apple Homepod, to receive user inputs from a user interface on the external device.

As shown more clearly in FIG. 1b the interior houses five plastic reservoirs or plug-in cartridges 6a, 6b, 6c, 6d, 6e. As FIG. 1a/1b shows schematically, these are arranged radially around the central longitudinal axis of the dispensing device 1. Each cartridge comprises a flattened bottle and houses an ingredient composition. For example, in this non-limiting illustrated embodiment, the reservoirs are as follows

6a a reservoir containing a composition comprising a surfactant;

6b a reservoir containing a composition comprising a first enzyme;

6c a reservoir containing a composition comprising a second enzyme, wherein the second enzyme is different to the first enzyme;

6d a reservoir containing a composition comprising a bleach component; and

6e a reservoir containing a composition comprising an alkaline component;

Each reservoir cartridge has a reservoir identifier which in this embodiment is an RFID device or ‘tag’. In further embodiments, the reservoir and system are as described for this embodiment, except that the reservoir identifier comprise a programmable microprocessor, small chip, disk, bar codes, optical character recognition (OCR), smart cards, biometrics (e.g. bio-recognition such as fingerprint, voice, iris, facial recognition system, proximity (prox) card, smart card, contactless smartcard, near field communication (NFC) devices, printed electronic id devices, or any combination of the above. It may comprise a computer readable medium, and carry computer executable instructions on the medium.

RFID tags 50a-50e are attached to respective reservoir cartridges 6a-6e each tag comprising a data carrier part (not shown). The reservoir identifier data carrier stores data regarding the condition of the reservoir.

Centrally positioned relative to all the cartridges is a RFID reader 50. The reader is part of a reservoir control system which effects controlled dosing from the cartridges and is also operative to modify (by writing to the said data carrier/s) stored on data carrier in response to the dosing regarding the dispensed ingredient compositions.

The reservoir identification device is comprised within the reservoir e.g. moulded within a reservoir wall or base or other part. This protects it from damage as the reservoir is inserted into the dispensing unit.

Preferably the RFID reader comprises directional antennas to emit concentrated RF power toward the targeted areas where the RFID tags are located on installed reservoirs. The RFID reader comprises a low gain antenna, preferably with gain less than 9 dBi to prevent communication before installation. The antenna is a proximity antenna with range s 2-10 cm preferably 2-8 cm. With this feature, the antenna can be powered to read only devices with are installed inside the dispensing device.

Beam width as used herein means the angle between two points on the same plane where the radiation falls to ‘half power’, or 3 dB below the point of maximum radiation. It can also be thought of as the peak effective radiated power of the main lobe. There are two beam widths—azimuth (horizontal) and elevation (vertical). Preferably the reader antenna emits a beam having at least the azimuth or the elevation beam widths being less than 90 degrees. The beam should be narrow and acute. This ensures the antenna is focused on the RFID tag only and that it does not waste energy.

The data carrier of the RFID tag on each reservoir carries information regarding the ingredient composition contained in that reservoir so that ingredient compositions are identified individually by the controller. The data also comprises manufacturing details e.g. location, date, recommended dosing data e.g. volume, mass, that may be useful for the washing/dispensing machine. This data can be displayed by a user interface. The data may be accessed by the dispenser/machine to determine a suitable washing program.

The data further relates to reservoir status i.e. quantity of ingredient composition contained/remaining in the reservoir. This data may be read by the identifier from the reservoir control system/computer module of a washing/dispensing machine and stored on the identifier. The quantity of ingredient composition may be calculated or measured directly. The reservoir control system (the RFID reservoir reader) has also write functionality and modifies certain data regarding its condition e.g. amount of ingredients contained can be updated. So for example, a reservoir control system may calculate fill levels according to a given initial fill volume/mass data (which may be calculated or provided e.g. Written to the data carrier during manufacturing) and subsequent dosage data. The control system may then update the condition data stored by the reservoir identifier's data carrier with the current fill levels.

Circular System of Reservoir Usage

The cartridges form part of a circular system of the above described reservoirs, use stations and recycling or ‘rejuvenation’ stations. The reservoirs move from station to station in a closed loop, being used and re-used without destructive/chemical recycling or being thrown away unless e.g. faulty or broken. Thus reservoirs are purchased by consumers, installed and used in e.g. washing machine and then when empty, reservoirs are returned to a recycling/rejuvenation facility where they are cleaned at a cleaning station and refilled at a refilling station. Re-filled reservoirs are then transported to retail stores or direct to consumers for re-sale and thus continue through this cycle. The reservoirs may continue looping again and again until withdrawn. New reservoirs can enter the system e.g. to replace broken, faulty reservoirs and begin looping the cycle of use and re-use, but the volumes needed to be manufactured can be lower. Throughout the system, reservoirs are monitored at various different stations.

The reservoirs travel through the following stations:
i. a use station (where the reservoir is used to dispense laundry product by e.g. consumer) and
ii. at least one reservoir cleaning station where the reservoir is cleaned;
iii. a reservoir filling and/or re-filling station where the reservoir is filled or re-filled with an ingredient composition.

The identifying tags of reservoirs are updated as they travel through the system. Reservoir controller is provided at the comprising at least one reader able to read said data relating to usage and/or treatment of the reservoir at each station.

Re-claimed reservoirs are treated and refilled with various ingredient compositions. The reservoirs are then ready for use again. They may be transported to a distributor or store for sale to consumers or transported direct to consumers.

To this end the data stored on the carrier comprises data relating to reservoir. Advantageously the data relates to the number of times the reservoir has been used i.e. any one or more of: having been filled with ingredient composition, used in a machine to dispense ingredient composition, cleaned; refilled, transported, stored. The data may include storage, transit, cleaning e.g. sanitizing data over time. This can ensure reservoirs spend appropriate time periods at certain stations e.g. cleaning stations so that hygiene standards are met.

Recording and monitoring of the reservoir status enables the implementation of a monitored and optimized circular system for using re-usable auto-dosing reservoirs

The reservoir controller also incorporates a data writer at each station for writing data regarding the status of the reservoir to a data carrier of the or each reservoir identifier. The controller controls the passage of the or each reservoir individually, to and from each station in response to data carried on the data carrier.

In this way the ‘life’ of the reservoir can be tracked for all key events of usage and treatment.

Preferably, each station comprises a reader operable to read the previous station. If the station recorded as the previously visited station is not the correct station according to the proper cycle then the reservoir In this way if a station is accidentally skipped

The or each reservoir preferably remains in the system for at least one entire cycle. Once cycle for an individual reservoir comprises use as in (a) and then treatment as in (b) and/or (c), preferably (b) and (c). Preferably the or each reservoir remains in the system for at least two cycles and more preferably at least three cycles and most preferably at least ten cycles.

The use station may comprise a washing machine in which the reservoir is installed, or in any way controllably, fluidly connected for dispensing of the ingredient composition from the reservoir or a standalone dispensing station separate from a washing machine, in which the reservoir is installed, or in any way controllably, fluidly connected for dispensing of the ingredient composition from the reservoir.

The reservoir cleaning station may effect sanitization of the reservoir by e.g. anti-bacterial treatments such as bleaching.

Preferably data is written to the data carrier of any reservoir along with corresponding time and date. So, the time spent by the reservation at any station is recorded. Time spent undergoing individual processes may be recorded to the reservoir's tag e.g. time spent undergoing detersive cleaning or rinsing.

In the case of the reservoir control system being connected (either directly or via a computer module which forms part of a washing/dispensing machine) to a remote retail system to enable automated replenishment, replacement, or upgrade of reservoirs and further preferably automatic delivery to the consumer, this may be in response to data carried on the data carrier. For instance if the data indicates that the reservoir has been through a specified number of cycles of the above circular system may trigger automated replenishment or replacement with a new reservoir which has not yet been through the circular system together with instructions to the consumer to recycle or return the reservoir to the manufacturer.

Preferably when a reservoir identifier is not present, or in the context of a reservoir identifier having an incorrect or deficient data, no treatment occurs and the reservoir is removed from the system for inspection.

The reservoir identifier is embedded/implanted in the container material. Attachment or embedding may be during moulding of the container or during subsequent processes, e.g. labelling of the reservoir. An advantage of this is that the reservoir can undergo cleaning and refilling without damage to the reservoir identifier as it is protected by the surrounding plastic material. Thus, the reservoir identifier can remain in place embedded in the reservoir at all times during the reservoir's passage through a cycle of the system and record all events. Embedded identifiers also resists counterfeiting and so ensure authenticity and therefore safety especially in the case of concentrated ingredients such as enzymes, bleaches, surface treatment agents e.g. waterproofing additives.

Formulations

6a Detergent Formulation

In this example, surfactant system is provided by linear alkyl benzene sulfonate (LAS) and C₁₀-C₁₅ alcohol ethoxylated nonionic surfactant with 2 to 7 EO.

6b 6c. Enzyme Formulations.

The device comprises two separate reservoirs 6b, 6c. Reservoir 6b contains a first ingredient composition comprising a protease (and suitably not containing a cellulase and/or a lipase) and a second further enzyme reservoir 6c contains a second ingredient composition comprising a cellulase and/or a lipase (and suitably not containing a protease). Neither, one or both of these compositions may then be supplied depending on, for example, the type of staining.

6d. Bleach Reservoir

This reservoir contains an ingredient composition comprising a bleach. This may be optionally dosed for white loads. The bleach in this example is employ 6-(phthalimido) peroxyhexanoic acid (PAP) and salts thereof. The peracid formula is shown below.

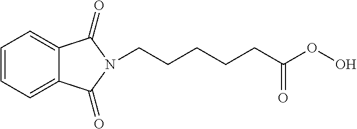 [SMILES: O=C(CCCCCN1C(=O)c2ccccc2C1=O)OO]

6d Alkaline Reservoir

The alkaline component for pH adjustment may be effected with alkalinity sources such as, but not limited to: alkanolamines, such as monoethanolamine MEA, diethanolamine, and triethanolamine TEA, and preferably MEA; alkali metal hydroxides, such as NaOH and KOH; alkali metal carbonates and bicarbonates such as sodium carbonate/bicarbonate and alkali metal silicates such as sodium silicate.

In further embodiments, alternative or further reservoirs are provide alternative or top up ingredients that may be present in the base formulation to provide a boost effect. For example, the applicant has observed large benefits for adding extra sequestrant into the wash cycle, over and above the amounts typically able to be formulated in laundry liquid formulations.

Cartridge Dispensing

Each cartridge has a valve 7. Each cartridge is in fluid communication via a respective valve 7 with the nozzle via a flow path 8. Each flow path 8 is equal in that the distance from each valve 7 to the nozzle is the same. Flow from the cartridge to the nozzle (where it is dispensed) is controlled by the valve 7. In this embodiment therefore each valve 7 is a metering valve, with the volume metered controlled by the computer module. It will be appreciated that the valves may be located at any point along the flow path, and other types of valve may be used. It will also be appreciated that metering of the ingredient compositions may be achieved in other ways, for example through generation of pressure in the reservoir to force the liquid out.

The diagram shows individual flows running from each reservoir to the nozzle 4. It will be appreciated that flow paths may meet before the nozzle is reached. For example, the device may have a pre-mixing chamber in which different ingredient compositions meet before they are dispensed into the dosing unit. In such embodiments, each flow path is equal in that the distance from each valve to the nozzle is the same.

In use, the dosing unit is located under the nozzle (such that product dispensed through the nozzle enters a chamber of the doing device). The user inputs information about the laundry load to the computer module. Typically, data may be entered in in two or more sets, each set requiring certain information from the user. For example, Set I may be used to input the load type: whites or colours. Set II may be used to input the presence or absence of staining and, optionally, the stain type. The user may therefore select whites, grass stains, mud stains. Other data requirements may include the fabric type (cotton/polycotton/polyester) as optimal fabric care benefit agents and amounts may be different in each case; fragrance selection (different members of the household may prefer different fragrances for their clothing, or it may be desirable to fragrance bedding and towels but not clothes); extent of staining (for example, lots of grass stains, only light mud stains); size of load (small loads may require less product).

An optimised wash composition is then determined and the appropriate amount from relevant cartridges dispensed. The computer module (not shown) controls the amount dispensed.

The recipe used to determine the amounts may be obtained from an internal memory within the device, or may be obtained from an external memory accessed, for example, via the internet. Often, particularly where there is more than one stain type, an algorithm may be employed to determine the optimised formulation, balancing the cleaning needs of certain stains against others.

In the apparatus as illustrated, 6a houses a detergent formulation, 6b houses an enzyme formulation, and 6c houses a whitening composition. Accordingly, if the user selects:
1. Colours→Not stained: the computer module may not dose the contents of 6b and 6c as the memory bank or algorithm may determine they are unnecessary.
2. Whites→Stained: the computer module may dose the contents of all three cartridges as the memory bank or algorithm may determine they are desirable.
3. Whites→Not stained: the computer module may not dose the contents of 6b as the memory bank or algorithm may determine it is unnecessary but may dose the contents of 6c (and 6a) as the memory bank or algorithm may determine it is desirable.
4. Colours stained: the computer module may not dose the contents of 6c as the memory bank or algorithm may determine it better for fabric care, but may dose the contents of 6b (and 6a) as the memory bank or algorithm may determine it is desirable.

As described herein, the device may be separate to a washing machine, for example on a countertop or built into kitchen units (so called, standalone), or may be integral to a washing machine. FIG. 2 illustrates an embodiment of the invention in which the device 101 is integral to a washing machine 10. The washing machine has a drum area 11 in which articles are laundered. As is conventional, this houses a rotatable basket into which articles to be laundered are placed (not shown). During a wash program, water and wash liquor enter the drum via a sprayer 12. Water enters the machine via inlet 13 (schematically and only partially shown). Water and wash liquor drain from the drum area 11 into a sump 14 and may then recirculate via recirculating pump 15 (arrows indicate direction) to be resprayed into the drum area, or may be drained via waste outlet 16. The device generally indicated at 101 which may comprise a housing within the machine, has five reservoirs radially arranged around a longitudinal axis of the device 101 here only three shown in this view: 17a, 17b, and 17c. The contents the five reservoirs correspond to those described for the standalone embodiment above.

Each reservoir cartridge has a reservoir identifier, which is in this embodiment an RFID device or ‘tag’. RFID tags (only 3 shown) 17a-17c are attached to respective reservoir cartridges (only three shown) 17a-17c. Positioned adjacent each cartridges is a corresponding RFID reader 50. The arrangement is as described above for the standalone dispensing device.

As shown, these are cartridges that engage with dispensing means 18. The cartridges may be loaded and changed through access flap 19.

The device has a computer module 20. As described herein the computer module controls which and optionally how much of each cartridge is dispensed. As shown here, the washing machine has a control panel 21 via which input may be provided to the computer module. As illustrated, the control panel is a touch screen. In the present case, the control panel and computer module are also the used to determine the machine program, although it will be appreciated that they may be separate.

As previously described, in use the user inputs information about the laundry load to the computer module 20. The optimised wash composition is then determined and the appropriate amount from relevant cartridges dispensed by dispensing means 18 and may be combined before entering the water flow of the machine, for example in a single pipe or chamber. This may be termed a pre-mixing area 27. As illustrated, three individual pipes combine to a single pipe, via which the product is dosed. In other words, the ingredient compositions dispensed may be at least partially premixed before being diluted to provide a wash liquor. The radial arrangement of the invention ensures each flow path is equal in that the distance from each valve to the pre-mixing area 27 is the same. The computer module controls the amounts dispensed.

It is to be understood that the examples and embodiments described herein are for illustrative purposes only.

1-14. (canceled)

15. A laundry system for dispensing one or more ingredient compositions from ingredient reservoirs for supplying to a washing machine drum, the laundry system comprising:
(i) an apparatus which comprises a dispensing device and multiple ingredient reservoirs;
(ii) said multiple ingredient reservoirs comprising a recycled material and containing the various ingredient compositions in controllable fluid communication with the dispensing device and each ingredient reservoir comprising at least one ingredient reservoir identifier;
(iii) said dispensing device comprising a nozzle being operable by means of a computer module to selectively dispense portions of the ingredient compositions from respective ingredient reservoirs as a result of commands by the user via a user interface to provide a dose of laundry product, and further comprising
(iv) an ingredient reservoir control system for controlling said selective dispensing of respective ingredient compositions from specific ingredient reservoirs identified by respective ingredient reservoir identifiers such that the device can selectively dispense ingredient compositions from one or more identified ingredient reservoirs
wherein the or each ingredient reservoir identifier comprises a data carrier for storing data regarding the condition of the ingredient reservoir and the ingredient reservoir control system is operative to modify the data stored on the data carrier, wherein the condition of the reservoir includes data regarding the recycled material, the reservoir's recyclability or both.

16. A circular system for using re-usable auto-dosing reservoirs, the system comprising:
a. at least one ingredient reservoir comprising a recycled material and containing an ingredient composition for supplying to a washing machine drum, wherein the ingredient reservoir comprises an ingredient reservoir identifier, said reservoir identifier comprising a data carrier operable to carry data relating to usage and/or treatment of the reservoir at one more stations; and
b. reservoir controller comprising at least one reader able to read said data relating to usage and/or treatment of the reservoir at one or more stations wherein said stations of the circular system comprise:
a. a use station and
b. a reservoir cleaning station where the reservoir is cleaned; and
c. a reservoir filling and/or re-filling station where the reservoir is filled or re-filled with an ingredient composition.

17. A method for dispensing one or more ingredient compositions from ingredient reservoirs each comprising a recycled material and containing various ingredient compositions for supplying to a washing machine drum, comprising the step of selectively dispensing from specifically identified ingredient reservoirs the or each reservoir comprising an ingredient reservoir identifier by which it is identified to the ingredient reservoir control system which controls said selective dispensing wherein the or each ingredient reservoir identifier comprises a data carrier for storing data regarding the condition of the ingredient reservoir, and the method further includes the step of modification of the data stored on the data carrier by ingredient reservoir control system, regarding the dispensed ingredient compositions, wherein the condition of the reservoir includes data regarding the recycled material or its/the reservoir's recyclability.

18. The method according to claim 17 which utilizes an apparatus comprising
a. a computer module which is configured to receive input concerning a laundry load based on one or more of the following criteria:
(i) stain identity;
(ii) fabric identity;
(iii) user requirements; and
(iv) user preferences;
and comprises the steps of:
a. providing input based on at least one of said criteria to the computer module and then
b. causing the device to determine, based on said information, a recipe for a laundry product which is optimised with respect to said input and composed of one or more ingredient compositions from respective ingredient reservoirs, and then
c. cause the device to effect controlled selective dispensing from specific ingredient reservoirs identified by an ingredient reservoir control system for controlling said selective dispensing of respective ingredient compositions from specific ingredient reservoirs identified by respective ingredient reservoir identifiers such that the device selectively dispenses ingredient compositions from one or more identified ingredient reservoirs; and
d. the ingredient reservoir control system is operative to modify said data stored on data carrier
wherein the or each ingredient reservoir identifier comprises a data carrier for storing data regarding the condition of the ingredient reservoir and the ingredient reservoir control system modifies the data stored on the data carrier regarding the dispensed ingredient compositions.

19. An ingredient reservoir comprising a recycled material and comprising an ingredient reservoir identifier, said reservoir identifier comprises a data carrier storing data relating to said treatment of the reservoir at any one or more of the stations:
a. a use station and
b. a reservoir cleaning station where the reservoir is cleaned;
and preferably
c. a reservoir filling and/or re-filling station where the reservoir is filled or re-filled with an ingredient composition supplying to a washing machine drum,

20. The ingredient reservoir according to claim 19 wherein the data carrier can store data regarding the condition of the reservoir itself.

21. The ingredient reservoir according to claim 19 wherein the data carrier stores data regarding the condition of the contents of the reservoir.

22. The ingredient reservoir according to claim 19 wherein the ingredient reservoir identifier is comprised within the reservoir and optionally contained within a reservoir wall or base or other part.
